(19) United States
(12) Patent Application Publication
(10) Pub. No.: US 2013/0182087 A1
(43) Pub. Date: Jul. 18, 2013

(54) INFORMATION PROCESSING APPARATUS AND DISPLAY CONTROL METHOD

(71) Applicant: KABUSHIKI KAISHA TOSHIBA, Tokyo (JP)

(72) Inventor: Fumitoshi MIZUTANI, Ome-shi (JP)

(73) Assignee: KABUSHIKI KAISHA TOSHIBA, Tokyo (JP)

(21) Appl. No.: 13/675,962

(22) Filed: Nov. 13, 2012

(30) Foreign Application Priority Data
Jan. 12, 2012 (JP) 2012-004042

(51) Int. Cl. H04N 13/04

(52) U.S. Cl. CPC H04N 13/0402
USPC 348/54

(57) ABSTRACT

According to one embodiment, an information processing apparatus includes a glassless three dimensional (3D) display capable of displaying a three-dimensional image. The apparatus includes a display, a detection module, and a setting module. The display is configured to display windows corresponding to application programs, each application program configured to support display of a three-dimensional image. The detection module is configured to detect a window observed by an observer. The setting module is configured to set a first region to a three-dimensional-image display region based on the observed window.

### CROSS-REFERENCE TO RELATED APPLICATIONS

This application is based upon and claims the benefit of priority from prior Japanese Patent Application No. 2012-004042, filed Jan. 12, 2012; the entire contents of which are incorporated herein by reference.

### FIELD

Embodiments described herein relate generally to an information processing apparatus comprising a glassless three-dimensional display, and a display control method applied to the apparatus.

### BACKGROUND

In recent years, various display apparatuses have been provided for watching stereoscopic images (or three-dimensional images). One of such display apparatuses is based on a glassless stereoscopic scheme (glassless three-dimensional scheme). The glassless stereoscopic scheme includes, for example, spatial division schemes by which a left-eye image and a right-eye image are simultaneously displayed on a liquid crystal display (LCD), and time-division display schemes by which left-eye images and right-eye images are alternately displayed.

For example, one of the time division display schemes is a scheme (a lenticular scheme or a parallax barrier scheme) by which a mechanism called parallax wall, which causes respectively different light rays to enter left and right eyes, controls directions of the emitted light corresponding to pixels in the left-eye and right-eye images.

According to the lenticular scheme or parallax scheme, a technology of detecting the position of a face of an observer and then controlling a direction of the emitted light corresponding to each of the pixels in an image in accordance with the detected position has been developed in order to allow the observer to properly perceive a stereoscopic image.

However, the ability to simultaneously set a plurality of regions as glassless three dimensional (3D) regions inside a screen is difficult to achieve in view of the problem of increased costs. Therefore, exclusive control of limiting the number of simultaneously executable 3D-support application programs to one is used conventionally.

However, there still is a demand for activating a plurality of 3D-support application programs. In this case, a preferred solution is to selectively display three-dimensional images which a user (observer) desires to watch.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an exterior of an electronic apparatus according to an embodiment.

FIG. 2 is a block diagram showing a system configuration of the electronic apparatus according to the embodiment.

FIG. 3 shows an example of windows displayed by a display when a plurality of application programs are activated.

FIG. 4 is a block diagram showing an example configuration of a 3D display system employed in the electronic apparatus according to the embodiment.

FIG. 5 is for explaining a method for estimating a sight direction of an observer.

FIG. 6 is for explaining a pixel-array transform processing which is performed by a pixel-array transformer.

FIG. 7 shows a flowchart of processing steps by a recognition controller.

### DETAILED DESCRIPTION

Various embodiments will be described hereinafter with reference to the accompanying drawings.

In general, according to one embodiment, an information processing apparatus includes a glassless three dimensional (3D) display capable of displaying a three-dimensional image. The apparatus includes a display, a detection module, and a setting module. The display is configured to display windows corresponding to application programs, each application program configured to support display of a three-dimensional image. The detection module is configured to detect a window observed by an observer. The setting module is configured to set a first region to a three-dimensional-image display region based on the observed window.

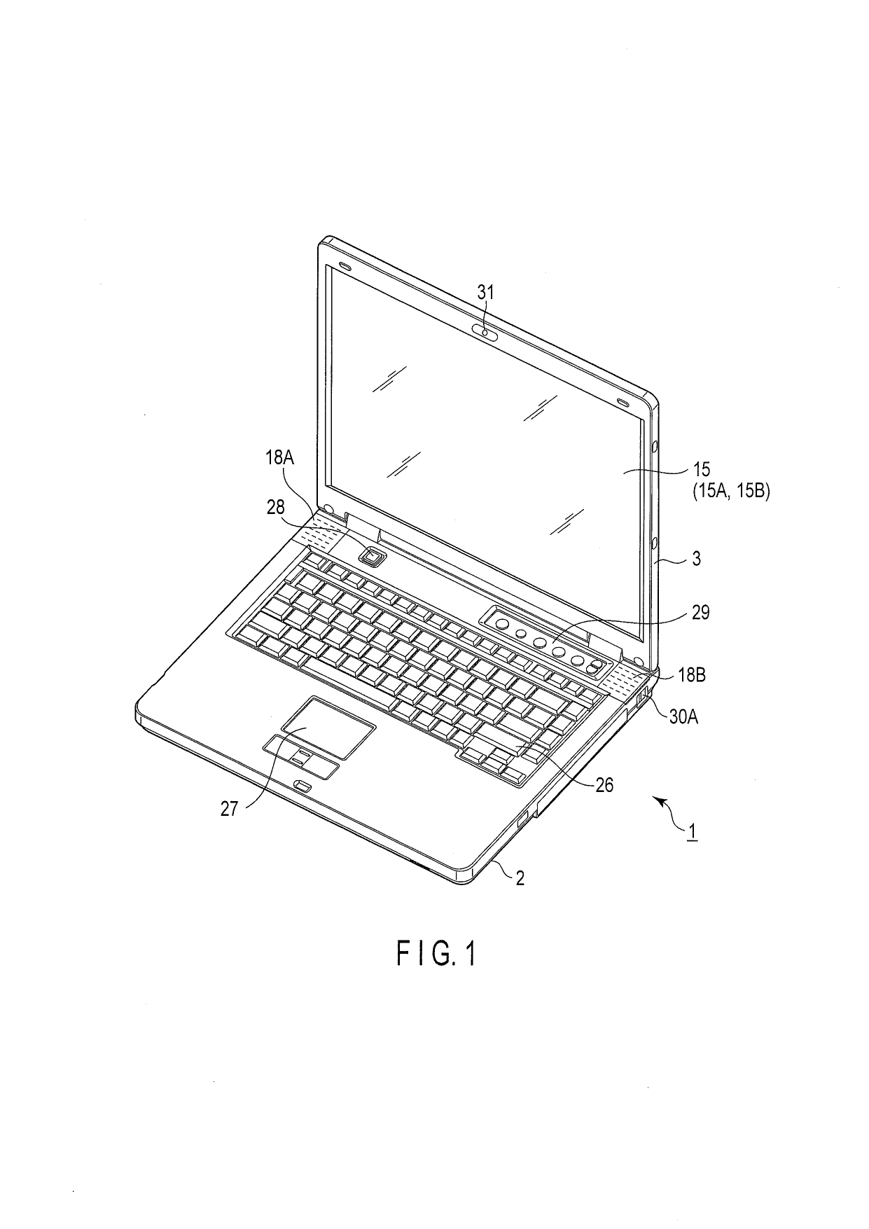

FIG. 1 is a perspective view showing an exterior of an information processing apparatus according to an embodiment. The information processing apparatus is produced as a notebook-type personal computer 1. The information processing apparatus may also be produced as a tablet PC, a PDA, or a smart phone.

As shown in FIG. 1, the present computer 1 comprises a computer body 2 and a display unit 3.

A glassless three-dimensional display (glassless three dimensional (3D) display) 15 is built in the display unit 3, and can display a three-dimensional image on a three-dimensional image display region which is set in the screen. The glassless 3D display 15 employs a glassless stereoscopic scheme (for example, an integral imaging scheme, a lenticular scheme, or a parallax barrier scheme) to display a three-dimensional image. A user can perceive the three-dimensional image by naked eye without glasses by looking at the image displayed on the glassless 3D display 15.

The display unit 3 is attached to a computer body 2 in a manner that the display unit 3 can be pivoted between an open position to expose an upper surface of the computer body 2 and a closed position to cover the upper surface. The glassless 3D display 15 further comprises a liquid crystal display (LCD) 15A and a lens unit 15B. The lens unit 15B is bonded to the LCD 15A. The lens unit 15B comprises a plurality of lens mechanisms for emitting a plurality of light rays corresponding to a plurality of pixels in predetermined directions, the pixels corresponding to a plurality of pixels included in the image displayed on the LCD 15A. The lens unit 15B is, for example, a liquid-crystal gradient index (GRIN) lens capable of electrically switching functions required for three-dimensional image display. Since the liquid crystal GRIN lens generates a refractive index distribution through electrodes by using a flat liquid crystal layer, the liquid crystal GRIN lens can display a three-dimensional image in a specified region in the screen while displaying a two-dimensional image in another region. That is, a three-dimensional image display region (glassless 3D display region) for displaying a three-dimensional image and a two-dimensional image display region for displaying a two-dimensional image can be partially switched inside the screen by changing the refractive indices of lenses between the region for displaying a three-dimensional image and the region for displaying a two-dimensional image.

In the glassless 3D region in the screen, for example, a left-eye image and a right-eye image are displayed alternately, with their pixels shifted in the horizontal direction. Further, light corresponding to pixels for the left-eye image and light corresponding to pixels for the right-eye image are refracted by a lens part for the glassless 3D region in a manner that the pixels for the left-eye image and the pixels for the right-eye image, which are displayed alternately, reach the left eye and the right eye, respectively. On the other side, in the two-dimensional image display region (2D region), light rays corresponding to the pixels for the two-dimensional image are emitted without being refracted by a lens part corresponding to the 2D region. The position and size of the region to be set as a glassless 3D region in the screen can be specified arbitrarily. The remaining region in the screen other than the glassless 3D region forms a 2D region.

The computer body 2 has a thin box-type housing. A keyboard 26, a power button 28 to power on/off the computer 1, an input operation panel 29, a pointing device 27, and loudspeakers 18A and 18B are provided on the upper surface of the housing. Various operation buttons are provided on the input operation panel 29. These grouped buttons include a group of buttons for controlling TV functions (watching, recording, and playback of recorded broadcasted program data/video data).

For example, an antenna terminal 30A for receiving a TV broadcast is provided on the right side of the computer body 2. On the back of the computer body 2, for example, there is provided an external display connection terminal in compliance with high-definition multimedia interface (HDMI) standards. The external display connection terminal is used to output image data (motion image data) included in image content data, such as broadcast program data, to an external display.

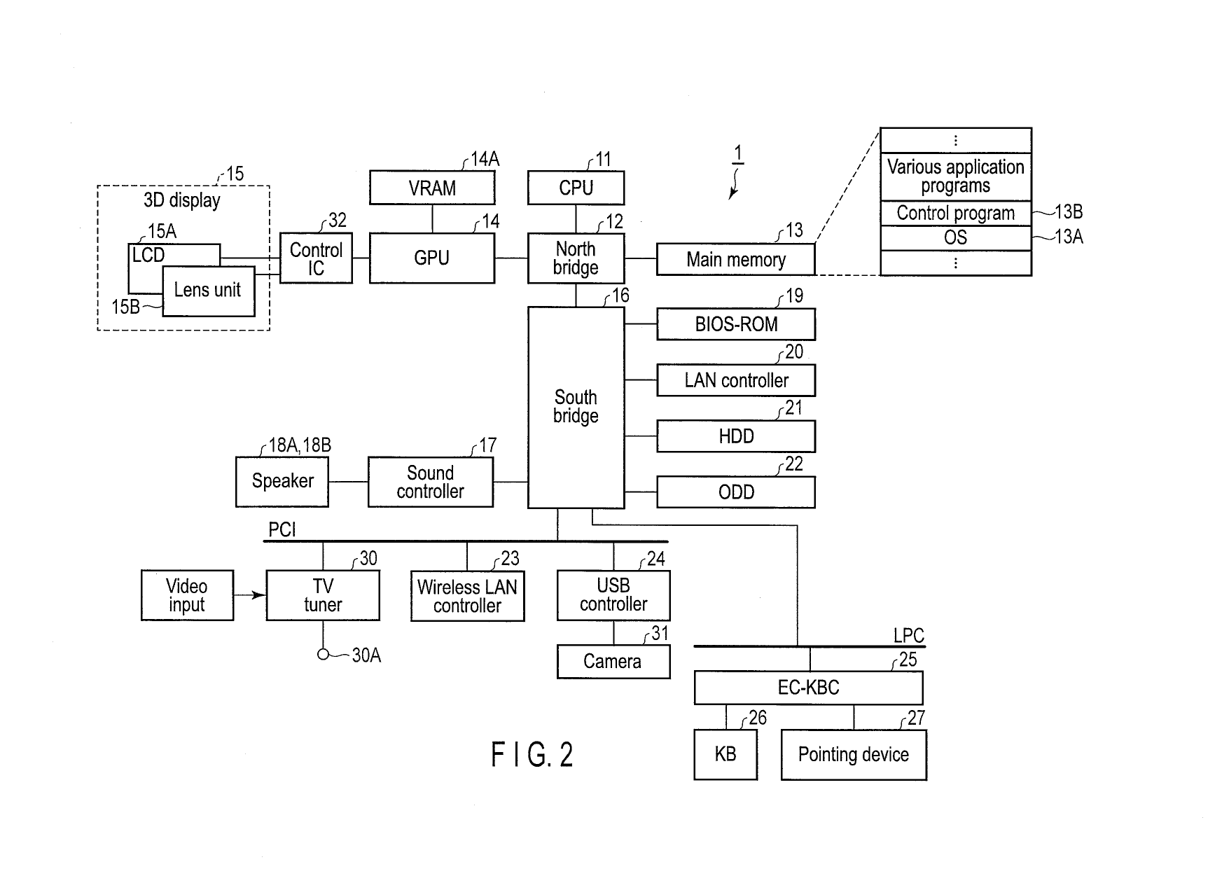

FIG. 2 shows a system configuration of the computer 1.

As shown in FIG. 2, the computer 1 comprises a central processing unit (CPU) 11, a north bridge 12, a main memory 13, a graphics processing unit (GPU) 14, a video memory (VRAM) 14A, the glassless 3D display 15, a south bridge 16, a sound controller 17, the loudspeakers 18A and 18B, a BIOS-ROM 19, a LAN controller 20, a hard disc drive (HDD) 21, an optical disc drive (ODD) 22, a wireless LAN controller 23, a USB controller 24, an embedded controller/keyboard controller (EC/KBC) 25, a keyboard (KB) 26, the pointing device 27, a TV tuner 30, a camera 31, and a control IC 32.

The CPU 11 is a processor which controls operation of the computer 1. The CPU 11 executes an operating system (OS) 13A, a control program 13B, and various application programs, which are loaded from the HDD 21 into the main memory 13. The application programs include several application programs which support 3D (hereinafter referred to as 3D application programs). The 3D application programs are, for example, a TV application program, a player application program, and a game application program.

The TV application program is for performing watching/listening and recording of broadcasted contents, and can deal with broadcasted program data in both of 2D and 3D formats. Known 3D formats are the side-by-side format and the top-and-bottom format, which include left-eye and right-eye images.

The TV application program has a 2D-3D conversion function which converts two-dimensional image data into three-dimensional image data, for each frame of broadcasted program data in the 2D format. In the 2D-3D conversion, a depth value is estimated for each pixel of two-dimensional image data. Based on the estimated depth value for each pixel, a plurality of parallax images such as two parallax images of left-eye and right-eye images are generated.

The player application program is for play back of video contents stored in storage media such as DVDs, and can deal with both 2D and 3D contents. The player application program may also have the 2D-3D conversion function as described above.

The control program 13B is for control of each of the 3D application programs. In common system design, the number of regions which can be set as glassless 3D regions is limited, for example, to one to avoid a cost increase. In order to simultaneously display different three-dimensional images respectively in a plurality of regions in a screen, a large number of hardware resources are required, which causes a cost increase.

Further, the CPU 11 also executes a basic input/output system (BIOS) stored in the BIOS-ROM 19. The BIOS is a program for hardware control.

The north bridge 12 is a bridge device which connects a local bus and the south bridge 16 to each other. The north bridge 12 also includes a memory controller which performs access control on the main memory 13. Further, the north bridge 12 has a function to make communication with the GPU 14.

The GPU 14 is a device which controls the LCD 15A used as a display of the computer 1. A display signal generated by the GPU 14 is fed to the LCD 15A. The LCD 15A displays images, based on the display signal.

The south bridge 16 controls devices on a peripheral component interconnect (PCI) bus and a low pin count (LPC) bus. The south bridge 16 includes a memory controller which performs access control on the BIOS-ROM 19 and an integrated-drive-electronics (IDE) controller for controlling the HDD 21 and ODD 22. The south bridge 16 further has a function to communicate with the sound controller 17 and LAN controller 20.

The sound controller 17 is a sound generator device and outputs audio data as a reproduction target, to the loudspeakers 18A and 18B. The LAN controller 20 is a wired communication device which performs wired communication, for example, according to the Ethernet (registered trademark) standards. The wireless LAN controller 23 is a wireless communication device which performs wireless communication, for example, according to the IEEE 802.11 standards. The USB controller 24 makes communication with external devices, for example, through a cable according to the USB2.0 standards.

The EC/KBC 25 is a single-chip microcomputer which integrates an embedded controller for performing power management, the keyboard (KB) 26, and a keyboard controller for controlling the pointing device 27. The EC/KBC 25 has a function to power on/off the computer 1 in accordance with operation by the user.

The TV tuner 30 is a receiver which receives broadcasted program data which is broadcasted by television (TV) broadcast signals, and is connected to an antenna terminal 30A. The TV tuner 30 is realized, for example, as a digital TV tuner which can receive digital-broadcast program data such as a terrestrial digital TV broadcast. The TV tuner 30 receives and decodes a broadcast signal, and outputs audio data and motion image data which includes left-eye and right-eye images. The TV tuner 30 also has a function to capture video data which is input from external devices.

The control IC 32 transforms arrays of pixels to be displayed in the glassless 3D region in a manner that a plurality of parallax images are arranged alternately in units of pixels in the horizontal direction. When a 3D image is displayed by using two parallax images including left-eye and right-eye images, arrays of pixels to be displayed in a glassless 3D region are transformed in a manner that the left-eye and right-eye images are displayed, alternately arrayed in units of pixels in the horizontal direction on the 3D region.

Further, in accordance with a request from the control program 13B, the control IC 32 controls a part of the lens unit 15B corresponding to the glassless 3D region in a manner that the part of the lens unit 15B has a predetermined refractive index distribution for 3D display. In this manner, a lens effect appears in this part of the lens unit 15B. Therefore, on the glassless 3D region, directions of emitted light rays corresponding respectively to the pixels of the left-eye image and directions of emitted light corresponding respectively to the pixels of the right-eye are controlled in a manner that the pixels of the left-eye image and the pixels of the right-eye image respectively reach the left and right eyes. In this case, there is a possibility that observation positions where the left-eye and right-eye images can be properly observed by the left and right eyes can be definitely limited.

Therefore, face tracking may be used upon necessity. In such face tracking, emitted light directions corresponding to the pixels of the right eye and those of the left eye are adaptively controlled, depending on the observation position of an observer (e.g., the position of the face or positions of the left and right eyes of the observer). In this manner, a view field where three-dimensional images are perceivable can be widened.

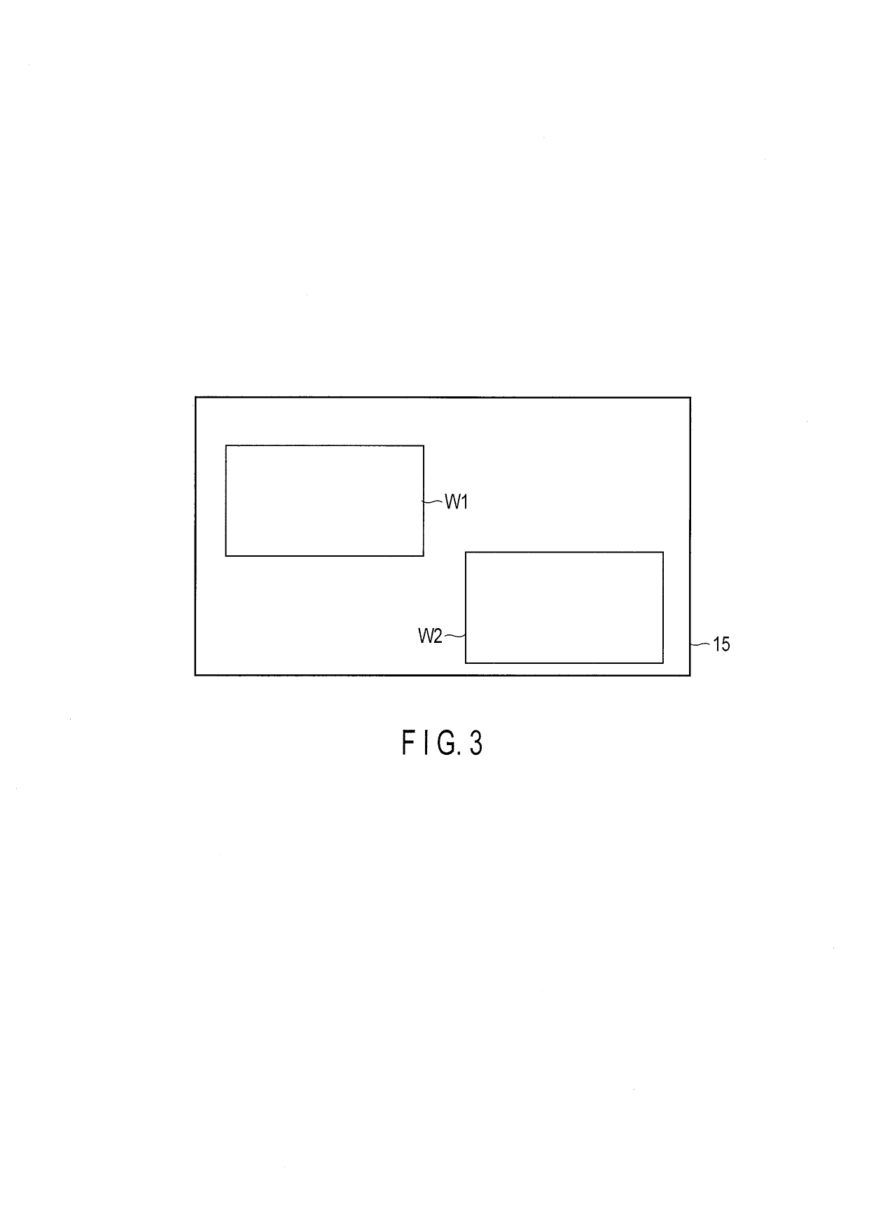

Next, referring to FIG. 3, a description will be made of three-dimensional display of only a window which is observed by the observer when a plurality of 3D application programs are activated.

In FIG. 3, a three-dimensional image is displayed on one of a window W1 of a first 3D application program and a window W2 of a second 3D application program. In FIG. 3, two-dimensional images are displayed respectively on the other one of the window W1 of the first 3D application program and the window W2 of the second 3D application program, and on the desktop screen. A region of the display screen corresponding to the aforementioned one of the windows W1 and W2 is set as a glassless 3D region.

The present apparatus 1 estimates a window which the observer observes (gazes at), based on motion image data imaged by a camera 31. Further, only the estimated window is set as the glassless 3D region to display a three-dimensional image.

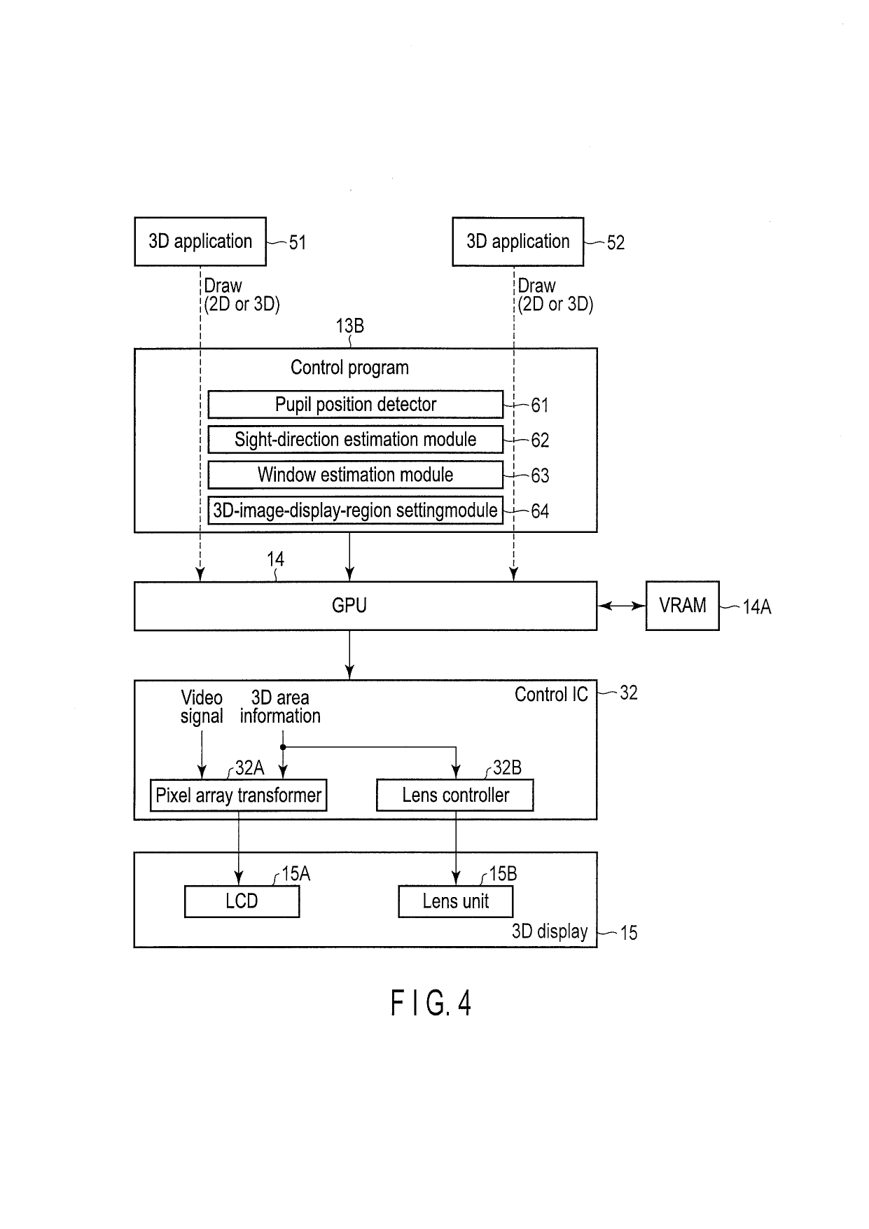

Next, referring to FIG. 4, a description will be made of an example configuration of a 3D display system employed in the present embodiment.

A first 3D-support application program 51 and a second 3D-support application program 52 exemplify a plurality of 3D-support application programs which are executed by the computer 1 according to the embodiment.

The first 3D-support application program 51 has a function to present the user content handled by the first 3D-support application program 51, in one of 3D and 2D modes. While the first 3D-support application program 51 is in the 3D mode, the first 3D-support application program 51 draws, on the VRAM 14A, a plurality of parallax images (for example, two parallax images including left and right eyes) corresponding to the content handled by the first 3D-support application program 51. In this case, the first 3D-support application program 51 may draw the left and right eye images on the VRAM by the side-by-side format. While the first 3D-support application program 51 is in the 2D mode, the first 3D-support application program 51 draws, on the VRAM 14A, a two-dimensional image corresponding to the content handled by the first 3D-support application program 51.

When the first 3D-support application program 51 is started up or when a 3D button on the screen of the first 3D-support application program 51 is pressed, the first 3D-support application program 51 transmits a request (3D request) for displaying a three-dimensional image, to the control program 13B.

Similarly, the second 3D-support application program 52 has a function to present the user content handled by the second 3D-support application program 52, in one of the 3D and 2D modes. While the second 3D-support application program 52 is in the 3D mode, the second 3D-support application program 52 draws, on the VRAM 14A, a plurality of parallax images (for example, two parallax images including left and right eyes) corresponding to the content handled by the second 3D-support application program 52. In this case, the second 3D-support application program 52 may also draw the left- and right-eye images on the VRAM by the side-by-side format. While the second 3D-support application program 52 is in the 2D mode, the second 3D-support application program 52 draws, on the VRAM 14A, a two-dimensional image corresponding to the content handled by the second 3D-support application program 52.

When the second 3D-support application program 52 is started up or when a 3D button on the screen of the second 3D-support application program 52 is pressed, the second 3D-support application program 52 transmits a request (3D request) for displaying a three-dimensional image, to the control program 13B.

The control program 13B comprises a pupil position detector 61, a sight-direction estimation module 62, a window estimation module 63, and a 3D-image-display-region setting module 64.

The pupil position detector 61 estimates positions of pupils (motion) relative to a face region of the observer when both the first application program 51 and the second application program 52 transmit the requests (3D requests) for displaying three-dimensional images.

The pupil position detector 61 detects the positions of the pupils from motion image data imaged by the camera 31. More specific detection of pupils relative to the face region will now be described below. At first, the pupil position detector 61 recognizes the region of the face of the observer, from respective frame image data included in motion image data. The pupil position detector 61 detects positions of the pupils of two eyes relative to the face region, within the detected face region.

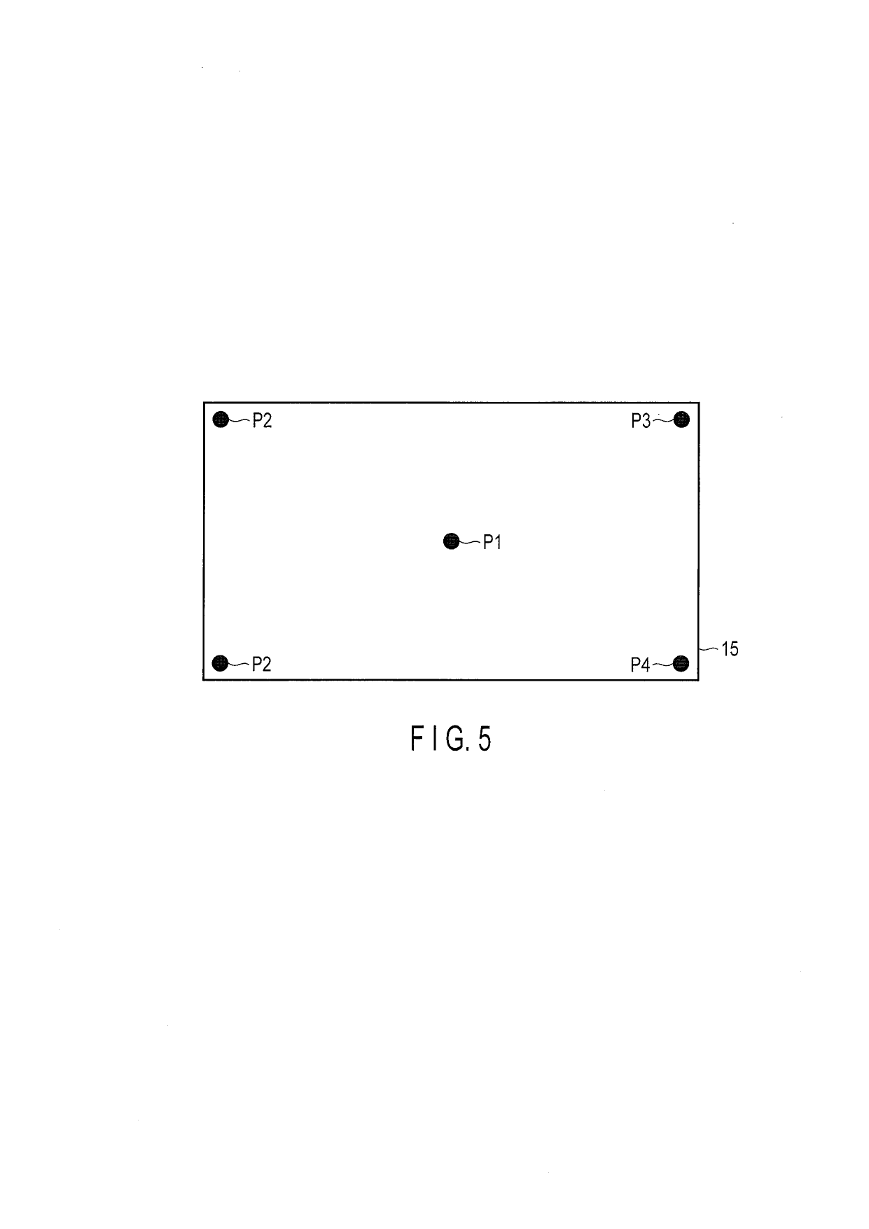

The sight-direction estimation module 62 estimates a sight direction of the observer, based on the positions of pupils relative to the face region. The window estimation module 63 obtains, in advance, positions of the two eyes relative to the face region when the observer gazes at a screen center P1, an upper left point P2, a lower left point P3, an upper right point P4, and a lower right point P5 of the glassless 3D display 15 (FIG. 5). The sight-direction estimation module 62 estimates a sight direction of the observer, based on the positions of two eyes relative to the face region, which are detected by the pupil position detector 61, and based on the positions of two eyes relative to the face region, which are obtained when the observer gazes at the screen center P1, upper left point P2, lower left point P3, upper right point P4, and lower right point P5.

The window estimation module 63 estimates a window which the observer observes (gazes at), depending on the estimated sight direction of the observer.

The 3D-image-display-region setting module 64 performs a processing to display three-dimensional images based on a plurality of parallax images which are drawn by a 3D application program.

When the window estimation module 63 estimates that the window of the first 3D application program 51 is observed, the 3D-image-display-region setting module 64 sets the first region in the screen, as a glassless 3D region, so that a three-dimensional image based on a plurality of parallax images corresponding to content handled by the first 3D application program 51 is displayed in the first region in the screen corresponding to the window of the first 3D application program 51. In this case, the 3D-image-display-region setting module 64 may transmit coordinate information which specifies the second region, to the control IC 32 in order to set the first region in the screen as a glassless 3D region.

Alternatively, when the window estimation module 63 estimates that the window of the second 3D application program 52 is observed, the 3D-image-display-region setting module 64 sets the second region in the screen, as a glassless 3D region, so that a three-dimensional image based on a plurality of parallax images corresponding to content handled by the second 3D application program 52 is displayed in the second region in the screen corresponding to the window of the second 3D application program 52. In this case, the 3D-image-display-region setting module 64 may transmit coordinate information which specifies the second region, to the control IC 32 in order to set the second region in the screen as a glassless 3D region.

The GPU 14 generates a video signal which forms a screen image, based on image data drawn on the VRAM 14A. The control IC 32 comprises a pixel array transformer 32A and a lens controller 32B. The pixel array transformer 32A receives the video signal from the GPU 14 and also receives 3D area information from the control program 13B. The 3D area information is coordinate information which indicates a region (for example, a rectangular region) in the screen, which is to be set as a glassless 3D region. The 3D area information may include four coordinate information items which respectively indicate four vertices of the rectangular region.

Based on the 3D area information, the pixel array transformer 32A extracts an image part corresponding to the glassless 3D region from an image of an entire screen corresponding to the received video signal. Further, the pixel array transformer 32A performs pixel-array transform processing on the extracted image part. Through the pixel-array transform processing, a plurality of parallax images included in the extracted image part are rearranged to be alternately arrayed in units of pixels in the horizontal direction. For example, when two parallax images including left-eye and right-eye images are used, the left-eye and right-eye images are rearranged in a manner that the left-eye image and the right-eye image are arrayed alternately in units of pixels in the horizontal direction. In this manner, in the glassless 3D region corresponding to the glassless 3D region on the screen of the LCD 15A, the left-eye and right-eye images are displayed alternately in units of pixels in the horizontal direction. The remaining image part other than the image part corresponding to the glassless 3D region is displayed on the LCD 15A without being subjected to the pixel array transform processing.

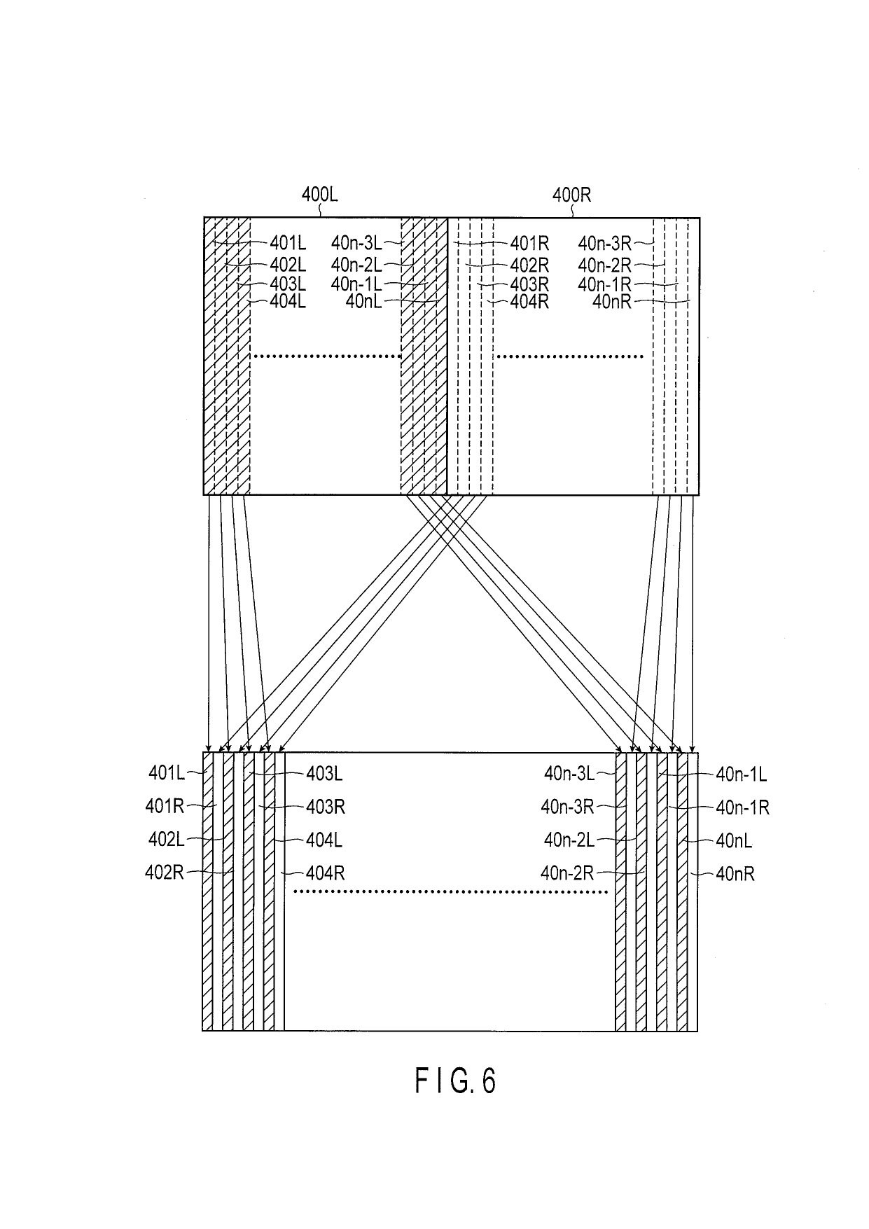

For example, according to the side-by-side format including a left-eye image 400L and a right-eye image 400R, as shown in FIG. 6, the pixel array transformer 32A performs the pixel array transform processing in a manner that pixels are arranged in an order of a first column image region 401L of the left-eye image 400L, a first column image region 401R of the right-eye image 400R, a second column image region 402L of the left-eye image 400L, a second column image region 402R of the right-eye image 400R, a third column image region 403L of the left-eye image 400L, a third column image region 403R of the right-eye image 400R, a fourth column image region 404L of the left-eye image 400L, a fourth column image region 404R of the right-eye image 400R, . . . “n−3”-th column pixel region 40n−3L of the left-eye image 400L, “n−3”-th column pixel region 40n−3R of the right-eye image 400R, “n−2”-th column pixel region 40n−2L of the left-eye image 400L, “n−2”-th column pixel region 40n−2R of the right-eye image 400R, “n−1”-th column pixel region 40n−1L of the left-eye image 400L, “n−1”-th column pixel region 40n−1R of the right-eye image 400R, “n”-th column pixel region 40mL of the left-eye image 400L, “n”-th column pixel region 40nR of the right-eye image 400R. In this manner, in the glassless 3D region on the screen of the LCD 15A, the left-eye and right-eye images are displayed alternately in units of pixels in the horizontal direction.

Based on the 3D area information, the lens controller 32B controls the lens unit 15B in a manner that a part of the lens unit 15B corresponding to the glassless 3D region has a predetermined refractive index distribution.

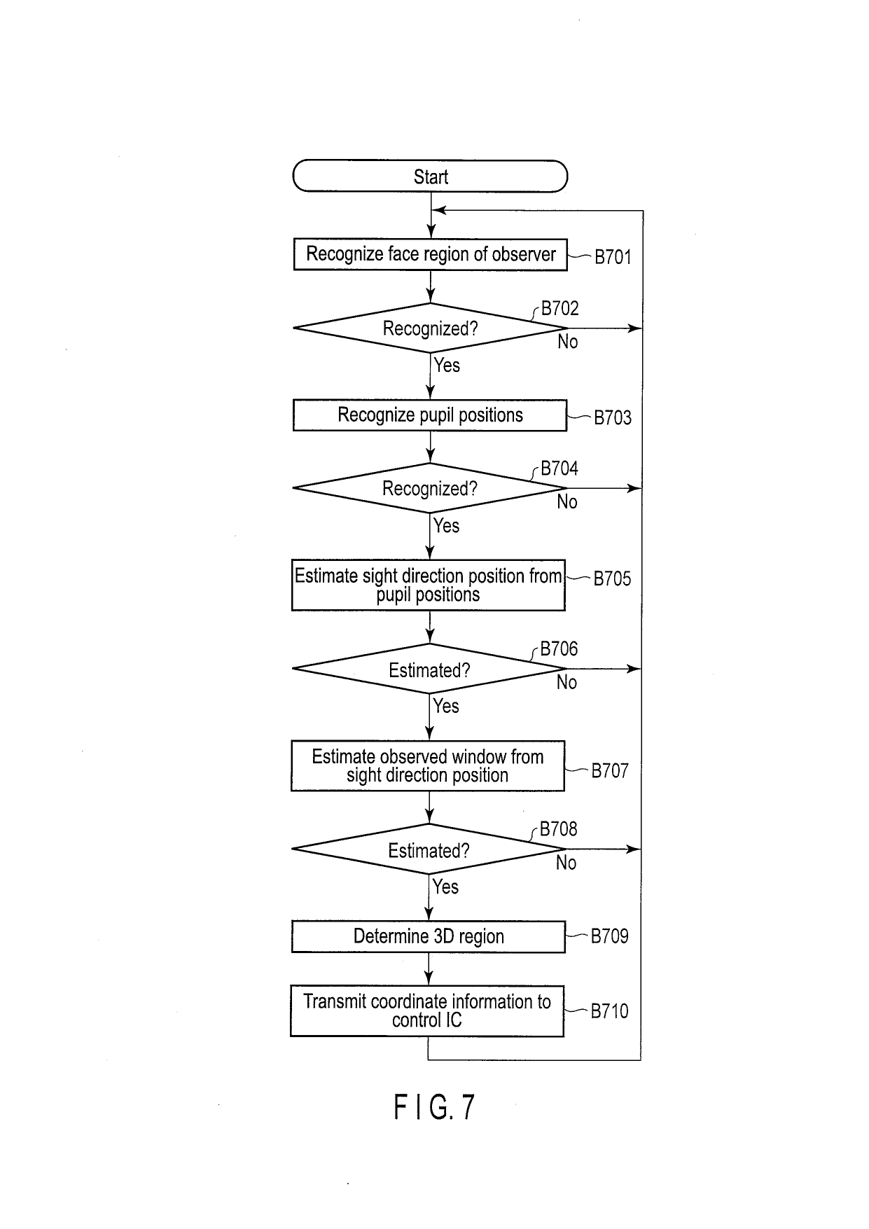

Next, the glassless-3D-region setting processing performed by the control program 13B will be described with reference to a flowchart in FIG. 7.

The pupil position detector 61 recognizes a face region of an observer from frame image data which is output from the camera 31 (Block B701). When the face region is recognized successfully (Block B702: Yes), the pupil position detector 61 recognizes positions of pupils relative to the face region, from the detected face region. When the positions of pupils relative to the face region are recognized successfully (Block B704: Yes), the sight-direction estimation module 62 estimates a sight direction of the observer from the detected positions of pupils relative to the face region. When the sight direction is estimated successfully (Block B706: Yes), the window estimation module 63 estimates a window corresponding to a 3D application program, which is observed by the observer, from the estimated sight direction. When the window corresponding to the 3D application program is estimated successfully from the estimated sight direction (Block B708: Yes), the 3D-image-display-region setting module 64 sets a 3D region, based on the estimated window (Block B709). The 3D-image-display-region setting module 64 transmits coordinate information of the glassless 3D region to the control IC 32 (Block B710).

According to the embodiment, when a plurality of application programs which support display of three-dimensional images are activated, a window (observed window) which the observer observes (gazes at) is estimated, and only the estimated window is set as a three-dimensional-image display region. A three-dimensional image which the observer wants to observe can therefore be selectively displayed.

The foregoing embodiment has been described with reference to a case that two application programs which support display of three-dimensional images are already activated. However, two application programs may be activated.

When two windows which support display of three-dimensional images overlap one another, only the upper one of the windows may be set as a three-dimensional-image display region.

Processing steps of the glassless 3D-region setting processing according to the present embodiment can entirely be performed by software. Therefore, the same effects as the above embodiment can be easily achieved by simply installing and executing a program in a computer with a glassless 3D region capable of displaying a three-dimensional image in a three-dimensional-image display region, from a computer-readable storage medium storing the program which executes the steps of the glassless 3D-region setting processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a glassless three dimensional (3D) display capable of displaying a three-dimensional image, the apparatus comprising:
a display configured to display windows corresponding to application programs, each application program configured to support display of a three-dimensional image;
a detection module configured to detect a window observed by an observer; and
a setting module configured to set a first region to a three-dimensional-image display region based on the observed window.

2. The apparatus of claim 1, further comprising:
a shooting module configured to shoot a motion image and to output motion image data comprising frame images;
a pupil position detector configured to detect positions of pupils of two eyes relative to a face region of the observer in the frame images;
a sight-direction estimation module configured to estimate a sight direction of the observer based on the positions of the pupils of the two eyes; and
an estimation module configured to estimate the observed window based on the estimated sight direction.

3. The apparatus of claim 1, further comprising:
a tuner configured to receive a broadcast signal and to demodulate the received broadcast signal in order to output audio data and motion image data comprising left-eye and right-eye images, wherein
a first application program of the application programs is configured to display the motion image data on a first window corresponding to the first application program.

4. The apparatus of claim 1, wherein a second application program of the application programs is configured to estimate a depth position for each pixel in an image frame of video data, and to generate left-eye and right-eye images corresponding to the image frame based on the depth position estimated for each pixel.

5. The apparatus of claim 1, wherein a third application program of the application programs is configured to reproduce data recorded in an optical disc in order to output audio data and motion image data comprising left-eye and right-eye images.

6. A display control method for use in an image processing apparatus comprising a glassless three dimensional (3D) display capable of displaying a three-dimensional image, the method comprising:
displaying windows on a screen, the windows corresponding to application programs, each application program configured to support display of a three-dimensional image;
detecting a window observed by an observer; and
setting a first region to a three-dimensional-image display region based on the observed window.

7. A computer-readable, non-transitory storage medium having stored thereon a computer program which is executable by a computer, the computer program controlling the computer to execute functions of:
displaying windows on a screen, the windows corresponding to application programs, each application program configured to support display of a three-dimensional image;
detecting a window observed by an observer; and
setting a first region to a three-dimensional-image display region based on the observed window.
